(19) United States
(12) Patent Application Publication
(10) Pub. No.: US 2024/0000127 A1
(43) Pub. Date: Jan. 4, 2024

(54) Food Ball Mold Apparatus for Making Stuffed Food Ball

(71) Applicant: James DeCartaret Bragg, Lintlaw (CA)

(72) Inventor: James DeCartaret Bragg, Lintlaw (CA)

(21) Appl. No.: 18/346,821

(22) Filed: Jul. 4, 2023

Related U.S. Application Data
(60) Provisional application No. 63/358,185, filed on Jul. 4, 2022.
(60) Provisional application No. 63/482,640, filed on Feb. 1, 2023.

(51) Int. Cl. A23P 30/10; A47J 43/20; A23P 20/25

(52) U.S. Cl. CPC A23P 30/10; A47J 43/20; A23P 20/25

(57) ABSTRACT

A food ball apparatus for forming a food material into a food ball includes first and second mold bodies arranged to be releasably joined to one another to define a ball mold cavity having a ball-shaped boundary in which each of the first and second mold bodies defines respective boundary portions of the ball-shaped boundary and respective cavity portions of the ball mold cavity. One of the ball molds may including a coring aperture to receive a coring tool to remove some food material from the food within the ball mold to allow ready insertion of a stuffing material. The ball molds may also be perforated to allow the mold to be submerged within a cooking fluid to cook the food within the ball mold while the ball mold retains the food in the shape of the mold.

This application claims the benefit under 35 U.S.C.119(e) of U.S. provisional application Ser. No. 63/358,185, filed Jul. 4, 2022 and U.S. provisional application Ser. No. 63/482,640, filed Feb. 1, 2023.

### FIELD OF THE INVENTION

The present invention relates to a mold apparatus for molding a food ball, for example an edible ball such as a meatball, cheeseball, or falafel, and more particularly the present invention relates to a food ball mold apparatus arranged to accept stuffing into the food ball.

### BACKGROUND

Various food items are commonly formed into a ball, for example meat balls, fish balls, cheese balls, and falafel. Such food balls are commonly formed using a ball mold comprised of two semi-spherical mold portions that are filled and then joined together to form the food ball. Stuffing the food balls generally requires placement of the stuffing material into the food material while the mold portions remain open and separated from one another; however, this results in an imprecise measure and placement of the stuffing material relative to the surrounding food material. The resulting stuffed ball may thus be difficult to properly cook and/or reproduce with the desired taste.

In some instances, food items which may be desirable to form into a ball, cannot be formed into a ball because those food items do not hold their shape well once released from a mold before cooking.

In other instances, it is desirable to place core food material within a pocket formed by a sheet of dampened rice paper, pastry, pasta, or dough and the like. This is commonly done by folding the sheet about the core food material and presses the sheet against itself to close the pocket before cooking. Occasionally, the sheet releases and the core food material escapes while cooking.

### SUMMARY OF THE INVENTION

According to one aspect of the invention there is provided a food ball apparatus for forming a food material into a food ball including a stuffing material contained therein, the apparatus comprising:
first and second mold bodies arranged to be releasably joined to one another to define a ball mold cavity having a ball-shaped boundary;
each of the first and second mold bodies defining respective boundary portions of the ball-shaped boundary and respective cavity portions of the ball mold cavity;
each of the cavity portions being arranged to receive respective portions of the food material therein to collectively form the food ball when joining the first and second mold bodies;
a coring tool arranged for forming a void in the ball mold cavity;
a coring aperture formed in the ball shaped boundary of the ball mold cavity through which the coring tool is arranged to be inserted into and removed from the ball mold cavity;
whereby the coring aperture is arranged to receive the stuffing material inserted therethrough upon removal of the coring tool.

The use of a coring tool together with a ball mold cavity having a coring aperture to receive the coring tool allows for accurate size and placement of the stuffing material with the food ball. The resulting food ball can be effectively cooked and tastes better when the proper stuffing and food material ratio can be accurately reproduced in a reliable manner.

The coring aperture may be located fully within the boundary portion of a first one of the first and second mold bodies.

In this instance, a release aperture may be formed within the boundary portion of a second one of the first and second mold bodies.

Preferably the coring tool is shaped to form a cylindrical shaped void.

The coring tool may comprise (i) an external portion arranged to be gripped in a hand of a user externally of the ball mold cavity and (ii) a penetrating portion arranged to be inserted into the ball mold cavity through the coring aperture, in which the penetrating portion comprises one or more protruding members extending longitudinally from the external portion so as to collectively define a perimeter boundary of a coring cavity arranged to remove a core of the food material from the ball mold cavity.

The one or more protruding members of the coring tool may comprise a plurality of elongate fingers extending axially from the external portion at circumferentially spaced apart positions so as to define a cylindrical shaped perimeter boundary.

Preferably the penetrating portion of the coring tool has a length that is greater than ½ a diameter of the ball mold cavity and less than a full diameter of the ball mold cavity.

A stop member is preferably formed on the coring tool between the penetrating portion and the external portion which is enlarged in dimension relative to the coring aperture so as to prevent insertion of the external portion of the coring tool into the ball mold cavity through the coring aperture.

An elongate passage preferably extends longitudinally through the external portion of the coring tool in open communication with the coring cavity.

The external portion of the coring tool may comprise a channel defining the elongate passage extending longitudinally therethrough and an elongate slot along one side of the elongate passage through which a finger of a user can be received.

In some embodiments, each of the first and second mold bodies includes a plurality of perforation apertures communicating through the mold body from the ball mold cavity to an external surface of the mold body.

Furthermore, each of the first and second mold bodies is preferably formed of a temperature resistant material arranged to resist a temperature of at least 350 degrees Fahrenheit.

The apparatus may be further configured such that (i) the first mold body includes a first rim surrounding a mold opening of the cavity portion of the first mold body, (ii) the second mold body includes a second rim surrounding a mold opening of the cavity portion of the second mold body, (iii) the first rim and the second rim engage one another when the first and second mold bodies are joined in a closed position to form the ball mold cavity, (iv) the first mold body and the second mold body are releasable from one another from the closed position in an axial direction, and (v) the first rim and the second rim are configured to overlap one another in the axial direction in the closed position.

The apparatus may be further configured such that (i) the first rim includes an end surface surrounding the mold opening and lying transversely to the axial direction, and (ii) the second rim is tapered in the axial direction to a pointed edge surrounding the mold opening and being arranged to abut the end surface of the first rim in the closed position of the mold bodies.

A linkage may be operatively connecting the first mold body to the second mold body such that the mold bodies are movable relative to one another between a closed position in which the mold bodies are joined to one another to define said ball mold cavity and an open position in which the mold bodies are separated from one another to allow insertion of the food material into the mold bodies.

According to a second aspect of the present invention there is provided a food ball apparatus for forming a food material into a food ball including a stuffing material contained therein, the apparatus comprising:
first and second mold bodies arranged to be releasably joined to one another to define a ball mold cavity having a ball-shaped boundary;
each of the first and second mold bodies defining respective boundary portions of the ball-shaped boundary and respective cavity portions of the ball mold cavity;
each of the cavity portions being arranged to receive respective portions of the food material therein to collectively form the food ball when joining the first and second mold bodies; and
each of the first and second mold bodies including a plurality of perforation apertures communicating through the mold body from the ball mold cavity to an external surface of the mold body.

Preferably each of the first and second mold bodies is formed of a temperature resistant material arranged to resist a temperature of at least 350 degrees Fahrenheit.

The use of perforations in the ball molds allows food items that normally do not hold their shape or form well before cooking to be cooked while remaining within the ball mold. When the ball mold is submerged into boiling water or cooking oil for frying, the heated fluid can penetrate the ball mold through the perforations to cook the food item while the ball mold continues to support the food item. Alternatively, when using sheeted food materials that do not hold together well as a closed pocket before cooking such as some types of rice paper, pastry, pasta, or dough and the like, the perforated mold bodies can retain the pocket closed while undergoing cooking.

According to a further aspect of the present invention there is provided a molding tool for use with the food ball apparatus described above in which the molding tool is used for forming a food sheet into a prescribed shape, the molding tool comprising:
a first molding frame including at least one first mold body formed thereon, said at least one first mold body forming a negative mold having a size and a shape corresponding to a size and a shape of the first mold body of the food ball apparatus; and
a second molding frame including at least one second mold body formed therein, said at least second mold body forming a positive mold having a size and a shape arranged to be received within said at least one first mold body of the first molding frame in a molding position;
wherein molding surfaces on said at least one first mold body and said at least one second mold body are separated from one another in the molding position by a clearance gap corresponding to a thickness of the food sheet; and
wherein one or both of said at least one first mold body and said at least one second mold body of the molding frames comprises a perforated member.

Preferably said at least one first mold comprises a plurality of first molds each having a semi-spherical shape, and said at least one second mold comprises a plurality of second molds each having a semi-spherical shape.

According to a further aspect of the present invention there is provided a method of using the molding tool described above in which the method comprises: (i) placing a flexible food sheet between the first and second mold frames; and (ii) drying the flexible food sheet between the first and second mold frames to form a semi-rigid food shell. Preferably the resulting food shell is sized and shaped to mate with one of the first or second mold bodies of the food ball apparatus described above.

### BRIEF DESCRIPTION OF THE DRAWINGS

Some embodiments of the invention will now be described in conjunction with the accompanying drawings in which:

FIG. 1 is a perspective view of the food ball apparatus showing the first and second mold bodies in a closed position relative to one another with the coring tool inserted therein;

FIG. 2 is a partially exploded view of the food ball apparatus according to the first embodiment of FIG. 1;

FIGS. 3 and 4 are side and top views respectively of the first mold body shown separated from the second mold body according to the first embodiment of FIG. 1;

FIG. 5 is a sectional view along the line 5-5 in FIG. 4;

FIGS. 6 and 7 are side and top views respectively of the second mold body shown separated from the first mold body according to the first embodiment of FIG. 1;

FIGS. 8, 9, 10 and 11 are front, side, top and bottom views respectively of the coring tool according to a first embodiment;

FIG. 12 and FIG. 13 are perspective view of the food ball apparatus according to a second embodiment in a partially closed position;

FIG. 14 is a side elevational view of the apparatus according to the second embodiment of FIG. 12;

FIG. 15 is a sectional view along the line 15-15 in FIG. 14;

FIGS. 16, 17 and 18 are first perspective, second perspective and side elevational view of the coring tool according to a second embodiment;

FIG. 19 is a side view of the ball mold and the coring tool according to a third embodiment of the food ball apparatus in a closed position;

FIGS. 20 and 21 are top and bottom views respectively of the food ball apparatus and the coring tool according to the third embodiment of FIG. 19;

FIGS. 22 and 23 are front and rear elevational views respectively of the food ball apparatus and the coring tool according to the third embodiment of FIG. 19;

FIG. 24 is a perspective view of a molding tool comprised of first and second molding frames for preparing cartridges for use in the food ball apparatus; and

FIGS. 25, 26 and 27 are front, top and side views respectively of the molding tool according to FIG. 24.

In the drawings like characters of reference indicate corresponding parts in the different figures.

### DETAILED DESCRIPTION

Referring to the accompanying figures, there is illustrated a stuffed food ball forming apparatus generally indicated by reference numeral 10. The apparatus 10 can be used to accurately place stuffing material into a food ball formed of various food materials, including meat balls, fish balls, cheese balls, falafel and the like.

Although multiple embodiments are shown in the figures, the common features of the various embodiments will first be described.

The apparatus 10 generally comprises (i) a ball mold 12 for forming the food material into a ball and (ii) a coring tool 14 for forming a void in the core of the food ball that receives stuffing therein. More particularly, the coring tool 14 may be arranged to be inserted into the ball mold 12 to cut and remove a core of the food material from the food ball, followed by subsequent placement of the stuffing material into the void in the core of the food ball.

The ball mold 12 is formed of a first mold body 16 and a second mold body 18 which can be joined together to collectively form a spherical ball mold cavity therein. Each of the mold bodies 16 and 18 has a semi-spherical wall defining a cavity portion therein that represents a portion of the spherical ball mold cavity. The semi-spherical wall of each mold body further defines a respective portion of an overall ball shaped spherical boundary of the ball mold when the first and second mold bodies are joined together.

The first mold body 16 further includes a first rim 17 which is generally circular in shape about a first axis of the first mold body while lying in a plane perpendicular to the first axis to surround a respective mold opening through which food material can be inserted to fill the ball mold cavity of the first mold when the mold bodies are separated from one another. Likewise, the second mold body 18 further includes a second rim 19 which is generally circular in shape about a second axis of the second mold body while lying in a plane perpendicular to the second axis to surround a respective mold opening through which food material can be inserted to fill the ball mold cavity of the second mold bodies are separated from one another.

The first and second mold bodies are pivotally coupled together by a linkage comprised of two handle members 20 in which one handle member 20 is fixedly attached to each of the first and second mold bodies. The handle members couple the first and second mold bodies relative to one another such that they are movable between a closed position and an open position in the axial direction of the mold bodies. In the closed position, the first and second rims 17 and 19 are abutted with one another to form the ball mold such that the first axis of the first mold body and the second axis of the second mold body are aligned with one another. In the open position, the first and second mold bodies are separated sufficiently from one another to allow food material to be filled into each cavity portion of the mold bodies through the respective mold openings which are substantially unobstructed by the opposing mold bodies. The mold bodies are supported by the linkage formed by the handle members so as to be initially displaced in an axial direction of the first and second axes relative to one another as the mold bodies are displaced away from the closed position towards the open position thereof.

The first and second handle members 20 are fixed immovably relative to the first and second mold bodies respectively. The handle members 20 extend generally radially outward from the ball mold in a common direction along intersecting paths when the mold bodies are closed. The handle members 20 are pivotally coupled at the intersection therebetween by a pivot shaft 22 that defines a pivot axis of the first mold body 16 and handle member 20 connected thereto relative to the second mold body 18 and handle member 20 connected thereto, in which the pivot axis is tangentially oriented relative to the ball mold cavity.

Each handle member 20 extends radially outward away from the ball mold beyond the pivot shaft 22 to define an outer handle portion 24 of each handle member in which the handle member is formed into a loop arranged to receive one or more fingers of a user therein. With respective fingers received within the loops of the two handle portions 24, the user can move the outer handle portions towards and away from one another which functions to move the first and second mold bodies towards and away from one another in a scissor type movement. The first and second mold bodies 16 and 18 are thus movable relative to one another by the pivoting of the handle members 20 between a closed position in which the mold bodies abut one another to form the closed spherical ball mold cavity therebetween and an open position in which the first and second mold bodies are sufficiently spaced apart for access to the respective cavity portions therein for filling with food material.

The first mold body 16 includes a coring aperture 26 extending through the wall of the mold body in communication between the cavity portion within the interior of the mold body and an exterior of the mold body. The coring aperture 26 is located near a centre of the mold body while being offset in a direction towards the respective handle member 20 mounted on the first mold body. The coring aperture 26 is suitably sized to allow insertion of a penetrating portion 28 of the coring tool to be inserted through the coring aperture into the interior ball mold cavity in use as described in further detail below.

The coring tool is an elongate, generally cylindrical shaped member extending along a longitudinal axis between the penetrating portion 28 located at a first end of the coring tool and an external portion 32 located at the opposing second end of the tool. The penetrating portion 28 is intended for insertion into the mold cavity through the coring aperture for forming a void within the food material that is formed into a ball within the ball mold cavity. More particularly, the penetrating portion is arranged for cutting and removing a core of the food material from the ball mold while the ball mold remains closed. The external portion 32 functions as a handle for gripping externally by the user while removing a core of food material from the ball mold, while also functioning to guide stuffing into the void created in the food material by coring.

The coring tool further includes an annular rim portion 34 located at an intermediate portion along the length of the coring tool between the penetrating portion 28 extending longitudinally from one side of the annular rim 34 and the external portion 32 extending longitudinally from the opposing side of the annular rim. The annular rim has an outer diameter or dimension which exceeds the corresponding diameter or dimension of the coring aperture 26 to function as a stop member which prevents insertion of the external portion of the coring tool into the ball mold through the coring aperture during coring. The length of the penetrating portion 28 extending longitudinally from the annular rim 34 is approximately between two thirds and three quarters of the interior diameter of the ball mold cavity such that the penetrating portion is inserted into the ball mold cavity only partway across the mold cavity by a distance corresponding to more than half of the diameter of the ball mold cavity but less than the full diameter of the ball mold cavity.

The penetrating portion 28 of the coring tool comprises a plurality of protruding members 36 defining elongate fingers respectively which extend axially from the annular rim in parallel relation to one another at evenly spaced apart positions about the circumference of the annular rim. The protruding members 36 collectively define a cylindrical boundary of the penetrating portion. Each protruding member 36 may include a pointed tip at the first end of the coring tool for ease of penetration into the food material that is formed into a ball within the ball mold.

In use, a user initially grips the external portion 32 of the coring tool and inserts the penetrating portion 28 of the coring tool into a food ball formed within the ball mold by inserting the penetrating portion through the coring aperture 26. Rotating the coring tool about a longitudinal axis of the coring tool serves to cut a core of food material along the cylindrical boundary of the protruding members 36 so that subsequent removal of the coring tool removes the cut core of food material from the ball mold with the coring tool.

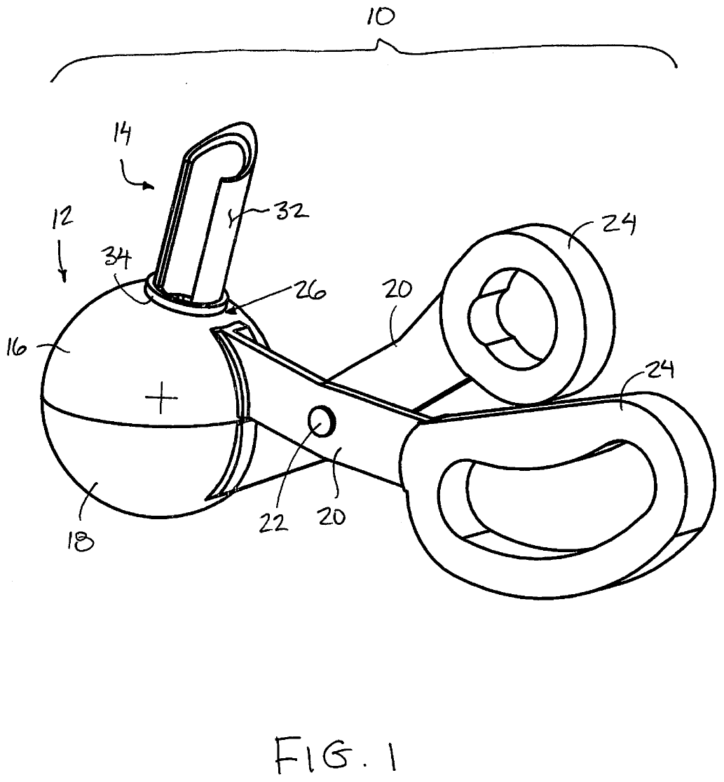

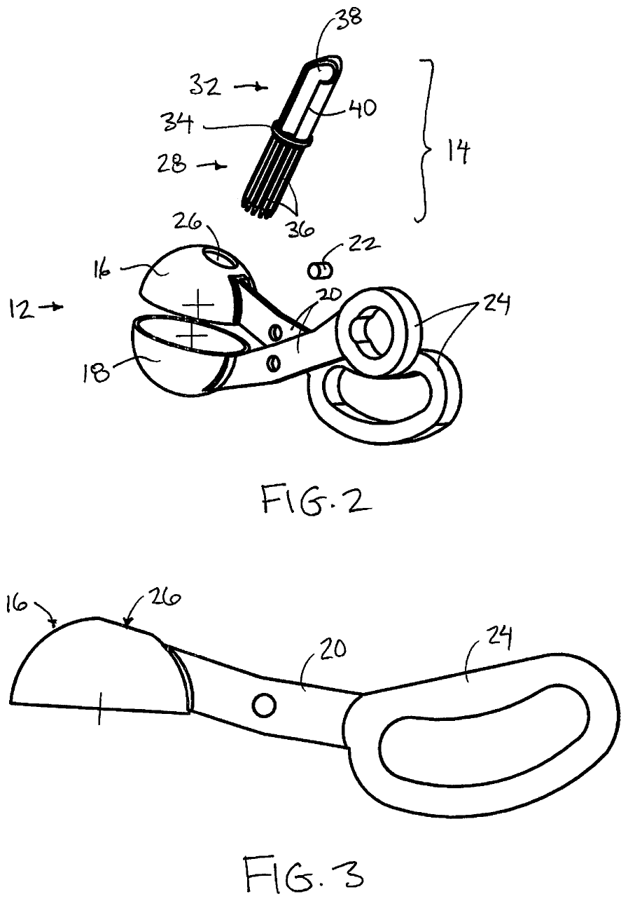

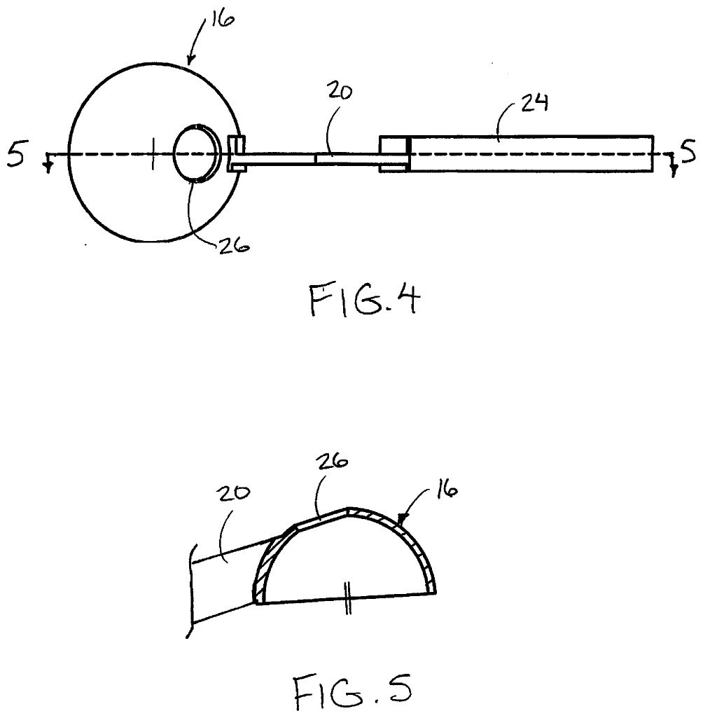

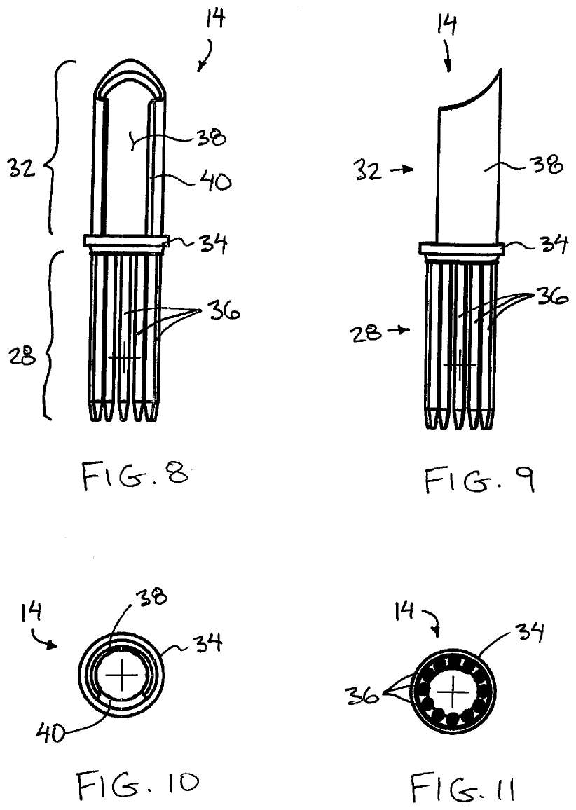

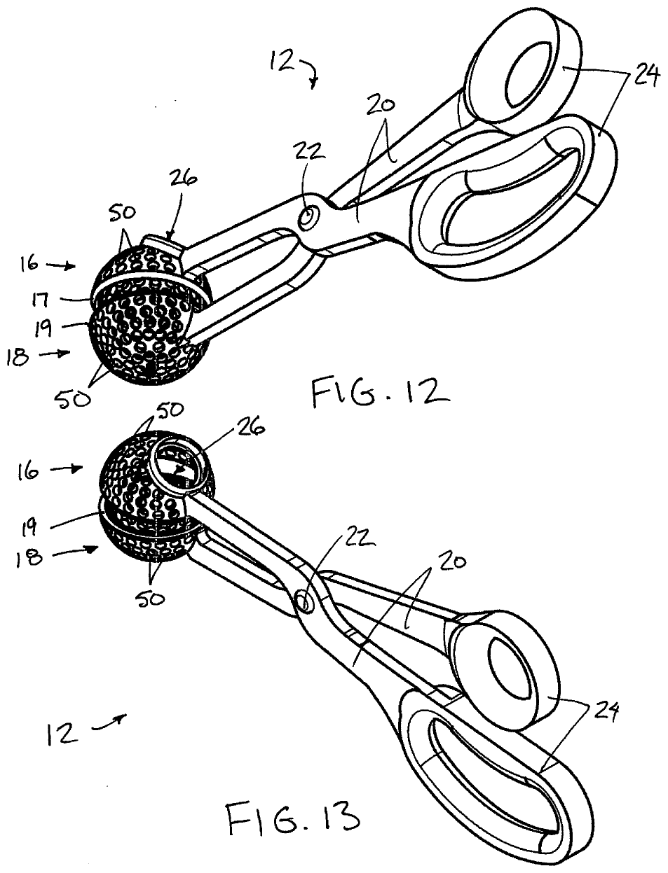

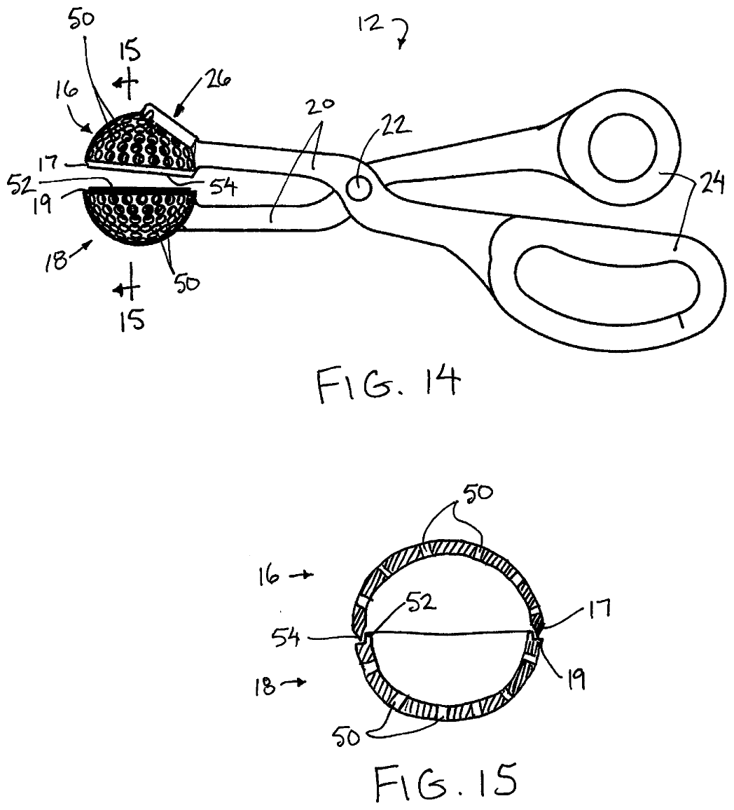

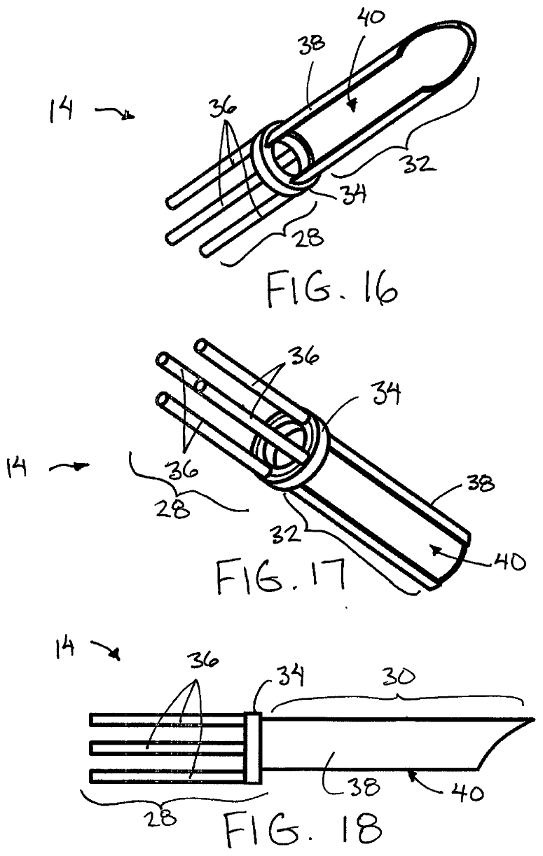

In the embodiments of FIGS. 1 through 18, the external portion 32 of the coring tool includes a semi-cylindrical wall 38 defining a generally U-shaped channel with an elongate passage therein extending along the full length of the external portion in the longitudinal direction. The wall 38 remains open along one side to define an elongate finger slot 40 extending longitudinally along the full length of the external portion in open communication with the elongate passage therein. The passage within the external portion is open at the outer end to the exterior of the coring tool while also being open at the inner end for open communication with the hollow interior of the penetrating portion defined by the cylindrical boundary of the protruding members 36. The open communication of a passage extending fully through the coring tool from an open end at the second end of the external portion to an open end at the first end of the penetrating portion allows a cut core of food material within the penetrating portion to be easily ejected from the coring tool once the core has been removed from the mold. The interior diameter of the passage within the external portion is approximately equal to the interior diameter of the cylindrical boundary defined by the protruding members 36 in the penetrating portion.

The external portion 32 can also be used for placement of stuffing material within the void in the food bowl formed by the coring tool. The user can scoop stuffing material into the passage of the external portion through the open end to properly portion the stuffing material. The penetrating portion 28 of the coring tool is then inserted into the ball mold through the coring aperture in the usual manner. A finger can then be inserted through the finger slot 40 of the external portion to slide the stuffing material within the external portion longitudinally through the passages into the penetrating portion for placement within the void in the food ball. The coring tool is then removed to leave the stuffing material placed within the food ball. Additional food material can be then inserted into the coring aperture 26 subsequent to removal of the coring tool to fully encapsulate the stuffing material within the food bowl in the ball mold.

The overall formation of a stuffed food ball begins by scooping food material into both mold cavity portions of the mold bodies. The mold bodies are then closed to form the food ball. The coring tool is subsequently used as described above for penetration into the food ball within the closed ball mold to cut and remove a core from the food ball. The cut core is removed from the coring tool subsequent to removal of the coring tool from the ball mold. The external portion of the coring tool can then be used to scoop a measured portion of stuffing material so that the stuffing material can be placed into the void within the food ball by reinsertion of the penetrating portion of the coring tool into the closed ball mold. Once the stuffing material has been displaced longitudinally from the external portion to the penetrating portion of the coring tool, the coring tool can be removed and additional food material inserted into the coring aperture 26 fully encloses and encapsulates the stuffing material within the food material of the food bowl. Opening of the mold bodies then enables the formed food ball to be released from the ball mold. The placement of the coring aperture 26 and other apertures in the opposing mold bodies assists in releasing the formed food ball from the ball mold by preventing suction between the food ball and the inner surface of each mold cavity.

Turning now more particularly to the first embodiment of FIGS. 1 through 11, in this instance the first rim 17 and the second rim 19 each comprise a flat end face lying in a common plane with the corresponding mold opening of the mold body so as to be substantially perpendicular to the corresponding first or second axis of the mold body.

Also in the figure embodiment of FIG. 1, the second mold body 18 includes a release aperture 30 extending through the wall of the mold body in communication between the cavity portion within the mold body and an exterior of the mold body. The release aperture 30 is located diametrically opposite from the coring aperture 26 when the mold bodies are closed relative to one another such that the release aperture is located near the centre of the semi-spherical wall of the second mold body 18. The release aperture may be similar in diameter or reduced in diameter relative to the coring aperture.

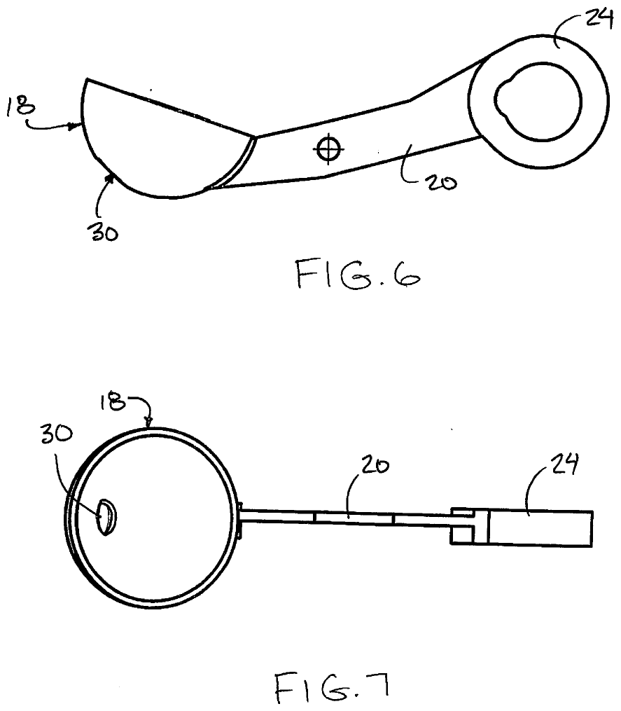

Furthermore, in the first embodiment of the coring tool 14 shown in FIGS. 8 through 11, the external portion 32 has a length in the axial direction which is similar in length to the length of the protruding members 36 as measured extending axially outward from the centrally located rim portion 34. The protruding members 36 in this instance are spaced apart in the circumferential direction such that the circumferential space between each adjacent pair of protruding members 36 is equal to or less than the corresponding width in the circumferential direction or diameter of each protruding member 36 so that the majority of the cylindrical boundary defined by the protruding members is occupied by protruding members rather than spaces between the protruding members.

Turning now to the second embodiment of FIGS. 12 through 18, the first and second mold bodies in this instance are both perforated such that each mold body includes a plurality of perforation apertures 50 communicating radially outwardly through the mold body from an interior boundary surface defining the ball mold cavity to an external surface at the exterior of the mold body. The perforation apertures have a suitable diameter and are spaced apart evenly relative to one another by a suitable distance such that between approximately 30% and 70% (and more preferably between 45% and 55%) of the surface area of the overall bowl-shaped boundary of the ball mold cavity is occupied by the apertures. The perforations allow penetration of heated cooking fluid, for example boiling water or heated cooking oil for deep frying, through the boundary of the mold cavity when the mold bodies are submerged within the cooking fluid to allow cooking of the food material while the food material remains within the closed mold bodies.

To allow the mold bodies to be submerged within the cooking fluid, the mold bodies and the connected handles 20 are formed of a heat resistant material which is arranged to resist a temperature of at least 100 degrees Celsius (212 degrees Fahrenheit) in the instance of cooking with boiling water, and more preferably a temperature of at least 176 degrees Celsius (350 Fahrenheit) in the instance of deep frying in cooking oil.

As a result of the perforation apertures 50, the second embodiment does not require a release aperture 30 according to the previous embodiment.

The ball mold 12 according to the second embodiment may be further adapted to cooperate with flexible sheets of food material such as dampened rice paper, pastry, dough or pasta, or alternatively pre-shaped semi-spherical cartridges of dry sheet material such as dry rice paper. In this instance, two sheets (flexible or cartridge) can line the first and second mold bodies 16 and 18 respectively when separated while permitting the two sheets to be joined together by the first rim 17 and the second rim 19 through the closing of the mold bodies relative to one another.

In this instance, the second rim 19 of the second mold body again includes an annular end face which is perpendicular to the axis of the however, the second rim in this instance further includes a raised collar 52 which protrudes axially outward from the annular end face towards the first mold body about the second axis of the second mold body. The collar 52 has an inner cylindrical surface which is substantially flush with the inner boundary surface of the second mold body and an outer cylindrical surface which is reduced in diameter relative to the remaining exterior surface of the mold body to define the annular end surface of the second rim as a shoulder at the exterior of the raised collar 52.

The first rim 17 of the first mold body in this instance is tapered in an outwardly axial direction towards the opposing mold body to form a pointed edge 54 which is annular in shape about the mold opening of the first mold body while lying in a plane that is perpendicular to the first axis. The pointed edge 54 has a diameter which is greater than the outer diameter of the raised collar 52 to permit the pointed edge 54 to abut the annular end face of the second rim 19 at the exterior of the raised collar 52 in the closed position of the mold bodies. In this manner, if sufficient force is applied in the direction of closing the first and second mold bodies towards one another, the pointed edge 54 can act as a circular knife that cuts against the corresponding end surface of the second mold body to trim any excess portions of the food material sheets that protrude outwardly beyond the boundary of the ball mold.

Furthermore, in the closed position, the pointed edge 54 of the first rim 17 overlaps the collar 52 of the second rim in the axial direction about the full perimeter of the mold body. In this instance, the collar 52 and the pointed edge 54 define a sinuous path between the interior boundary of the ball mold cavity and the exterior surface of the ball mold through which the flexible sheets of food material traverse as the mold bodies are closed towards one another to effectively clamp the two sheets against one another, thereby effectively closing the pocket formed by the sheets for retaining core food material within the pocket. The sheets may be clamped with one another with sufficient force to cause the food material sheets to bond with one another to remain closed as a pocket once released from the ball mold before cooking. Alternatively, due to the perforations in the mold bodies, the food sheets can remain clamped in the closed position to form a closed pocket while the mold bodies are submerged in a cooking fluid to cook the pocket while the pocket remains closed under force of the mold bodies.

Furthermore, in the second embodiment of the coring tool 14 shown in FIGS. 16 through 18, the external portion 32 has a length in the axial direction which is greater than the length of the protruding members 36 as measured extending axially outward from the centrally located rim portion 34. The protruding members 36 in this instance are spaced apart in the circumferential direction such that the circumferential space between each adjacent pair of protruding members 36 is more than double the corresponding width in the circumferential direction or diameter of each protruding member 36 so that the majority of the cylindrical boundary defined by the protruding members is occupied by spaces between the protruding members rather than protruding members.

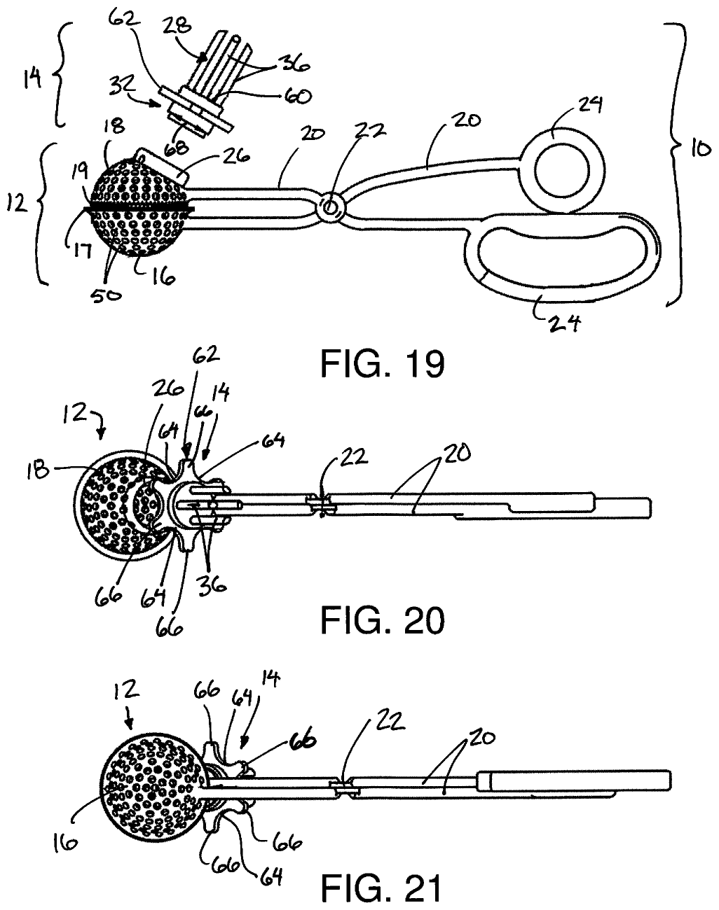

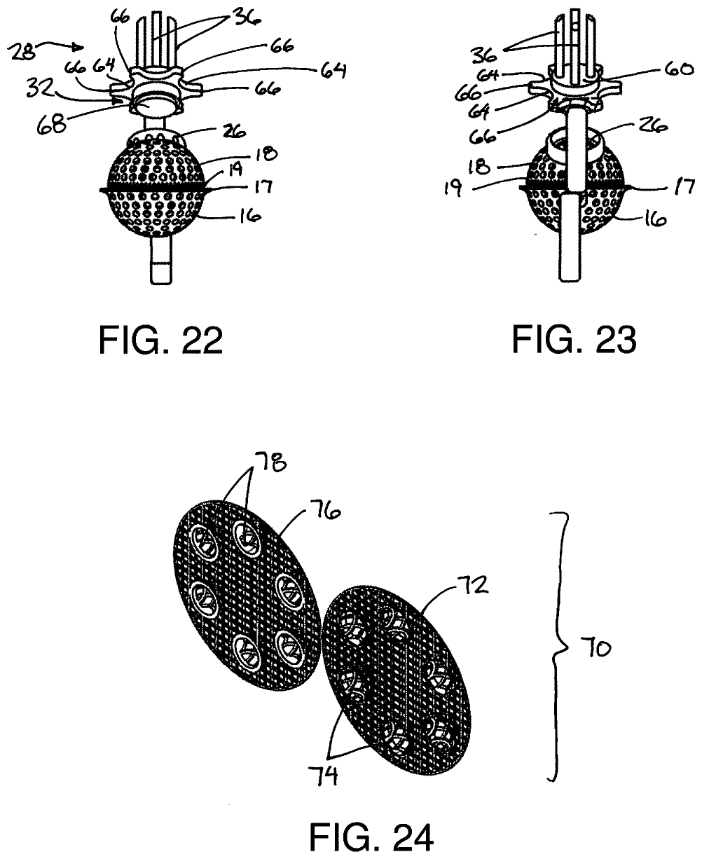

Turning now to FIGS. 19 to 23, a further embodiment of the food ball apparatus 10 is illustrated. In this instance, the ball mold 12 is configured substantially identically to the previous embodiment of FIG. 14 so as to comprise a first mold body 16 and a second mold body 18 connected by handle members 20 which are pivotally coupled by a pivot shaft 22 in which the mold bodies comprise perforated apertures 50 together with a coring aperture 26 in one of the mold bodies.

In the embodiment of FIG. 19, the ball mold differs from the previous embodiment with regards to the configuration of the first rim 17 and the second rim 19. In this instance the first rim comprises a flange which protrudes at a slope extending radially outward as the flange extends axially outward from the open side of the first mold body towards the opposing second mold body.

The second rim 19 tapers radially inwardly as the surface extends axially outward from the open side of the second mold body 18 towards the opposing first mold body. The second rim is sized to nest within the perimeter flange of the first rim when the first and second mold bodies are mated with one another to function to press the edges of food sheets lining the first mold body and the second mold body respectively together with one another.

The arrangement of the rims 17 and 19 is particularly useful when the ball mold 12 is prepared by lining each of the first and second mold bodies with a food sheet such as wetted rice paper or seaweed paper because the food sheets lining the two mold bodies can be pressed together about the perimeter edges where the mold bodies meet one another by the first rim 17 nesting within the second rim 19 as the mold bodies are joined together.

As with previous embodiments, a stuffing material can be placed within the food sheets prior to joining the mold bodies together so that a ball shaped pocket of stuffing material is encapsulated by the food sheets. Subsequently submerging the mold bodies within a cooking fluid such as hot frying oil allows the food sheets to be joined to one another during the cooking process to form the finished food ball. Protruding edges of the food sheets extending beyond the rims of the mold bodies can be trimmed before or after the cooking step.

The coring tool 14 according to the embodiment of FIG. 19 includes a penetrating portion 28 substantially identical to the previous embodiments; however, the inner end of the penetrating portion in this instance remains closed by an end wall 60 spanning diametrically across the inner end of the penetrating portion such that the protruding members 36 extend perpendicularly outward from the end wall 60.

The external portion 32 of the coring tool in this instance includes a radial flange 62 extending radially outward from the end wall 60 about the full circumference thereof. Recesses 64 are formed at circumferentially spaced positions about the circumference of the radial flange 62 such that a protruding gripping member 66 is defined between each adjacent pair of recesses 64 with the resulting protruding grip members being circumferentially spaced about the circumference of the external portion. Each recess is suitably sized to receive a finger of a user therein to define finger grips to apply a twisting torque to the coring tool when used for removing a cylindrical core from the food ball as described above.

The external portion 32 of the coring tool in this instance also includes a cylindrical plug 68 protruding axially from the radial flange 62 opposite to the protruding members 36 of the penetrating portion 28. The plug 68 is a cylinder-shaped body having an outer diameter which closely fits within the inner diameter of the coring aperture 26. The cylindrical body of the plug 68 has an axial protruding height relative to the radial flange 62 which corresponds approximately to the depth of the coring aperture 26 in an axial direction of the coring aperture. In this instance, the plug 68 can be inserted into the coring aperture until the radial flange 62 abuts the exterior of the mold body, at which point an inner end surface of the plug 68 is substantially flush with the inner molding surface of the mold body locating the coring aperture 26 therein, for example to provide support to the food material within the ball mold during a frying step.

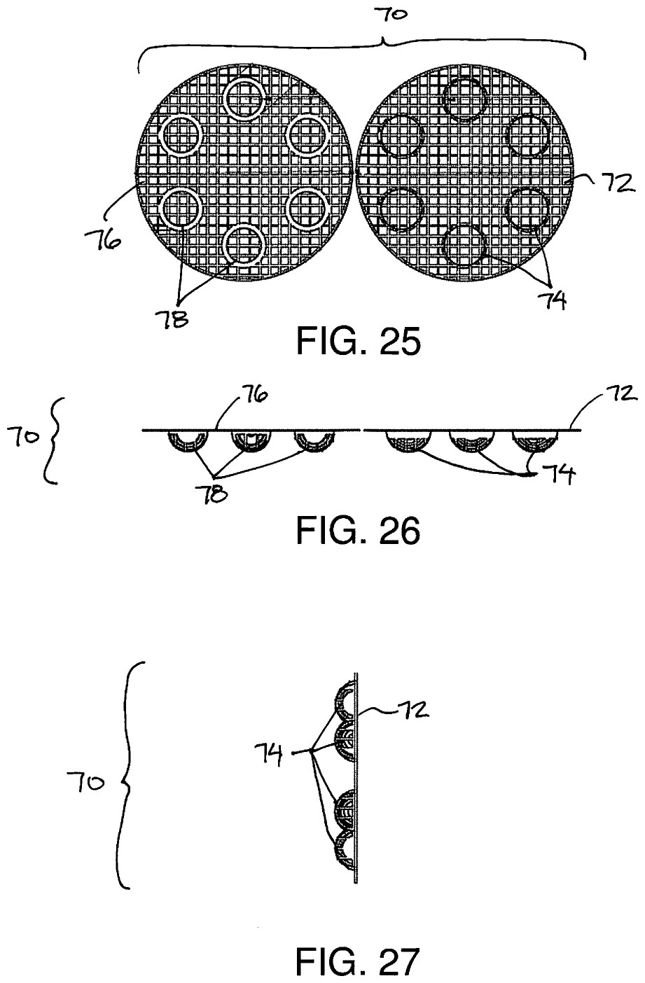

Turning now to FIGS. 24 through 27, a molding tool 70 is illustrated for use together with the food ball apparatus 10 described above. More particularly, the molding tool includes a first molding frame 72 in the form of a flat circular plate which locates a plurality of first mold bodies 74 formed thereon at circumferentially spaced positions about the plate. Each of the first mold bodies 74 is a negative mold defining an internal mold cavity which is sized and shaped to correspond to the interior mold cavity dimensions of either one of the first mold body 16 or the second mold body 18 of the food ball apparatus. The first mold bodies 74 thus defined semi-spherical mold cavities therein.

The molding tool 70 further includes a second molding frame 76 also formed as a circular plate which supports a plurality of second mold bodies 78 thereon at circumferentially spaced positions about the plate. The plate is shaped and sized to be approximately equal to the shape and size of the plate of the first molding frame which in turn corresponds to the round shape and size of commonly available rice paper sheets. The second mold bodies 78 are positioned for alignment with corresponding ones of the first mold bodies in the first molding frame when the first and second molding frames are abutted adjacent one another in a molding position. Each second mold body 78 defines a positive mold having a semi-spherical shape which is sized and shaped to be received within the interior dimensions of a corresponding first mold body. More particularly in the mounted position, the positive molding surface of each second mold body 78 fits within the negative mold surface of the corresponding first mold body 74 to define a uniform clearance gap between the molding surfaces in which the gap is approximately equal to a thickness of a food sheet to be formed such as a rice paper sheet.

The entirety of each of the first molding frame and the second molding frame is formed of a mesh or perforated material having openings therein. In this manner a moistened food sheet such as rice paper can be placed between the first and second mold frames and dried into a finished semi-rigid form. The first and second mold frames are abutted with one another in the molding position so that the food sheet between the frames forms food shells having a semi-spherical shape at each cooperating pair of a second mold body 78 with a corresponding first mold body 74. The molding frames remain in the molding position until the food sheets become sufficiently dry that the formed semi-spherical food shells become semi-rigid in shape forming a food cartridge that is sized for closely fitting and mating within either one of the first mold body 16 or the second mold body 18 of the ball mold 12.

The food shells prepared by the molding tool 70 can be manufactured at one location and then used at a separate location with the food ball apparatus 10. The food shells are used by placing an individual food shell within each of the first and second mold bodies followed by filling of the food shells with a stuffing food material. Closing the ball mold 12 traps the stuffing material between two food shells. Once the ball mold is submerged within a cooking fluid, such as frying within hot oil, the food shells become fused together to form a finished food ball.

In further embodiments, seaweed paper known as Nori sheets can be used in place of rice paper to similarly form food shells using the molding tool 70 so that the food shells formed of Nori sheets can similarly be used within the ball mold apparatus as described above.

In further arrangements, wet or partly dried rice paper sheets or Nori sheets can be directed placed in the ball mold by lining the first and second mold bodies prior to filling with stuffing, followed by closing the mold and cooking by submerging in a cooking liquid such as fry oil.

Since various modifications can be made in my invention as herein above described, and many apparently widely different embodiments of same made, it is intended that all matter contained in the accompanying specification shall be interpreted as illustrative only and not in a limiting sense.

1. A food ball apparatus for forming a food material into a food ball including a stuffing material contained therein, the apparatus comprising:
first and second mold bodies arranged to be releasably joined to one another to define a ball mold cavity having a ball-shaped boundary;
each of the first and second mold bodies defining respective boundary portions of the ball-shaped boundary and respective cavity portions of the ball mold cavity;
each of the cavity portions being arranged to receive respective portions of the food material therein to collectively form the food ball when joining the first and second mold bodies;
a coring tool arranged for forming a void in the ball mold cavity;
a coring aperture formed in the ball shaped boundary of the ball mold cavity through which the coring tool is arranged to be inserted into and removed from the ball mold cavity;
whereby the coring aperture is arranged to receive the stuffing material inserted therethrough upon removal of the coring tool.

2. The apparatus according to claim 1 wherein the coring aperture is located fully within the boundary portion of a first one of the first and second mold bodies.

3. The apparatus according to claim 2 further comprising a release aperture formed within the boundary portion of a second one of the first and second mold bodies.

4. The apparatus according to claim 1 wherein the coring tool is shaped to form a cylindrical shaped void.

5. The apparatus according to claim 1 wherein the coring tool comprises (i) an external portion arranged to be gripped in a hand of a user externally of the ball mold cavity and (ii) a penetrating portion arranged to be inserted into the ball mold cavity through the coring aperture, the penetrating portion comprising one or more protruding members extending longitudinally from the external portion so as to collectively define a perimeter boundary of a coring cavity arranged to remove a core of the food material from the ball mold cavity.

6. The apparatus according to claim 5 wherein the one or more protruding members of the coring tool comprise a plurality of elongate fingers extending axially from the external portion at circumferentially spaced apart positions so as to define a cylindrical shaped perimeter boundary.

7. The apparatus according to claim 5 wherein the penetrating portion of the coring tool has a length that is greater than ½ a diameter of the ball mold cavity and less than a full diameter of the ball mold cavity.

8. The apparatus according to claim 5 further comprising a stop member on the coring tool between the penetrating portion and the external portion which is enlarged in dimension relative to the coring aperture so as to prevent insertion of the external portion of the coring tool into the ball mold cavity through the coring aperture.

9. The apparatus according to claim 5 further comprising an elongate passage extending longitudinally through the external portion of the coring tool in open communication with the coring cavity.

10. The apparatus according to claim 9 wherein the external portion of the coring tool comprises a channel defining the elongate passage extending longitudinally therethrough and an elongate slot along one side of the elongate passage through which a finger of a user can be received.

11. The apparatus according to claim 1 wherein each of the first and second mold bodies includes a plurality of perforation apertures communicating through the mold body from the ball mold cavity to an external surface of the mold body.

12. The apparatus according to claim 11 wherein each of the first and second mold bodies is formed of a temperature resistant material arranged to resist a temperature of at least 350 degrees Fahrenheit.

13. The apparatus according to claim 11 further comprising:
the first mold body including a first rim surrounding a mold opening of the cavity portion of the first mold body;
the second mold body including a second rim surrounding a mold opening of the cavity portion of the second mold body;
the first rim and the second rim engaging one another when the first and second mold bodies are joined in a closed position to form the ball mold cavity;
the first mold body and the second mold body being releasable from one another from the closed position in an axial direction; and
the first rim and the second rim being configured to overlap one another in the axial direction in the closed position.

14. The apparatus according to claim 11 further comprising:
the first mold body including a first rim surrounding a mold opening of the cavity portion of the first mold body;
the second mold body including a second rim surrounding a mold opening of the cavity portion of the second mold body;
the first rim and the second rim engaging one another when the first and second mold bodies are joined in a closed position to form the ball mold cavity;
the first mold body and the second mold body being releasable from one another from the closed position in an axial direction;
the first rim including an end surface surrounding the mold opening and lying transversely to the axial direction; and
the second rim being tapered in the axial direction to a pointed edge surrounding the mold opening and being arranged to abut the end surface of the first rim in the closed position of the mold bodies.

15. The apparatus according to claim 1 further comprising a linkage operatively connecting the first mold body to the second mold body such that the mold bodies are movable relative to one another between a closed position in which the mold bodies are joined to one another to define said ball mold cavity and an open position in which the mold bodies are separated from one another to allow insertion of the food material into the mold bodies.

16. A food ball apparatus for forming a food material into a food ball including a stuffing material contained therein, the apparatus comprising:
first and second mold bodies arranged to be releasably joined to one another to define a ball mold cavity having a ball-shaped boundary;
each of the first and second mold bodies defining respective boundary portions of the ball-shaped boundary and respective cavity portions of the ball mold cavity;
each of the cavity portions being arranged to receive respective portions of the food material therein to collectively form the food ball when joining the first and second mold bodies; and
each of the first and second mold bodies including a plurality of perforation apertures communicating through the mold body from the ball mold cavity to an external surface of the mold body.

17. The apparatus according to claim 16 wherein each of the first and second mold bodies is formed of a temperature resistant material arranged to resist a temperature of at least 350 degrees Fahrenheit.

18. A molding tool for use with the food ball apparatus according to claim 1 for forming a food sheet into a prescribed shape, the molding tool comprising:
a first molding frame including at least one first mold body formed thereon, said at least one first mold body forming a negative mold having a size and a shape corresponding to a size and a shape of the first mold body of the food ball apparatus; and
a second molding frame including at least one second mold body formed therein, said at least second mold body forming a positive mold having a size and a shape arranged to be received within said at least one first mold body of the first molding frame in a molding position;
wherein molding surfaces on said at least one first mold body and said at least one second mold body are separated from one another in the molding position by a clearance gap corresponding to a thickness of the food sheet; and
wherein one or both of said at least one first mold body and said at least one second mold body of the molding frames comprises a perforated member.

19. The molding tool according to claim 18 wherein said at least one first mold comprises a plurality of first molds each having a semi-spherical shape, and said at least one second mold comprises a plurality of second molds each having a semi-spherical shape.

20. A method of using the molding tool according to claim 18, the method comprising:
placing a flexible food sheet between the first and second mold frames;
drying the flexible food sheet between the first and second mold frames to form a semi-rigid food shell, the food shell being sized and shaped to mate with one of the first or second mold bodies of the food ball apparatus according to claim 1.
